(19) United States
(12) Patent Application Publication
(10) Pub. No.: US 2009/0262700 A1
(43) Pub. Date: Oct. 22, 2009

(54) FREQUENCY DOMAIN DIRECT SEQUENCE SPREAD SPECTRUM WITH FLEXIBLE TIME FREQUENCY CODE

(76) Inventors: Michael R. Franceschini, Centerport, NY (US); Martin A. Stern, Fort Wayne, IN (US)

Correspondence Address: STRATEGIC PATENTS P.C.., C/O PORTFOLIOIP, P.O. BOX 52050, MINNEAPOLIS, MN, 55402, US

(21) Appl. No.: 12/423,479

(22) Filed: Apr. 14, 2009

Related U.S. Application Data
(63) Continuation-in-part of application No. 09/802,280, filed on Mar. 8, 2001.
(60) Provisional application No. 60/188,084, filed on Mar. 9, 2000.

(51) Int. Cl. H04W 4/00

(52) U.S. Cl. 370/330

(57) ABSTRACT

A spread spectrum radio frequency communication system includes a Forward Error Correction (FEC) algorithm to encode digital data to provide a plurality of symbol groups, the FEC algorithm using a Reed Solomon FEC code, an interleaving algorithm to map each one of the plurality of symbol groups into a corresponding one of a plurality of coherent sub-bands, and a Walsh encoder to encode each one of the plurality of symbol groups.

### CROSS-REFERENCE TO RELATED APPLICATIONS

This application is a continuation-in-part of U.S. application Ser. No. 09/802,280 filed on Mar. 8, 2001, which claims the benefit of U.S. App. No. 60/188,084 filed on Mar. 9, 2000. Each of the foregoing commonly-owned applications is herein incorporated by reference in its entirety.

### FIELD

This invention relates generally to communication systems and more particularly to systems and techniques to reduce the effects of heavy absorption of direct signal path propagation and the effects of multipath.

### BACKGROUND

Modern communication requirements demand reliable and timely communications in highly restrictive terrain and in severe multipath fading conditions found both inside buildings and outside in urban areas. Wireless or mobile radio communications suffer severe degradations in performance in restrictive terrain, such as in urban environments and within buildings. This is typically due to heavy absorption of the direct path signal energy combined with significantly strong specular multipath bounces (i.e. bounces off of discrete objects. such as buildings and walls). The multipath signals cause in-band fading that reduces the signal energy in small fragments of spectrum at a time, while other frequency components may be unfaded, or even enhanced by added multipath energy. For narrowband signals, this means that a desired receive frequency may be attenuated beyond use and rendered unrecoverable, unless excessive transmitter power is used to provide tens of dB of fade margin. For wideband signals, unfaded segments of the band may have enough residual signal energy to make up for the lost energy in the faded segments, making reception possible, however, severe distortion (intersymbol interference, amplitude/phase dispersion, etc.) still makes receiver recovery a difficult signal processing challenge.

The traditional approach to solving the frequency selective multipath fading problem is either to use frequency diversity such as transmitting on more than one frequency and use multiple receivers, but this is expensive, wasteful of spectrum, and if both channels are faded will still fail, or to use a wideband signal format that spans wider than frequency selective fades. The latter is the preferred state-of-practice, such as for spread spectrum CDMA/PCS cellular techniques. A newer OFDM (Orthogonal Frequency Division Multiplexing) signal format is also being explored, such as by European commercial HDTV developers, that processes each of many parallel frequencies independently such that unfaded signals are processed cleanly in an undistorted narrow coherent bandwidth, and frequency selective faded frequencies are discarded. Redundancy is used to recover the information lost in discarded frequencies.

Multi-Carrier Modulation (MCM) is a technique of transmitting data by dividing the stream into several parallel bit streams, each of which has a much lower bit rate, and by using these sub streams to modulate several carriers. Orthogonal Frequency Division Multiplexing (OFDM), a special form of MCM with densely spaced sub carriers and overlapping spectra is described in U.S. Pat. No. 3,488,445 and issued in Jan. 6, 1970. OFDM abandoned the use of steep bandpass filters that completely separated the spectrum of individual sub carriers, as it was common practice in older Frequency Division Multiplex (FDMA) systems, in Multi-Tone telephone modems and as used in Frequency Division Multiple Access radio. OFDM time-domain waveforms are chosen such that mutual orthogonality is ensured even though sub carrier spectra may overlap. Such waveforms can be generated using a Fast Fourier Transform at the transmitter and receiver.

It has been learned from earlier experiments with wireless data transmission that the selection of the modulation technique is highly critical. In the early days of mobile communications, many attempts to connect a telephone modem to a cellular phone failed because of mobile channel anomalies. With the demand for wireless data communications, experiments and product tests revealed that mobile fading channel needed specific solutions for the modulation technique, bit rate, packet length and other aspects. In conventional modulation techniques, dispersion (as described in terms of a channel delay spread and intersymbol interference) reduces the maximum achievable rate. Equalization can mitigate this to some extent, but typically at the cost of increased noise, so it leads to a transmit power tradeoff or an increased vulnerability to interference. Alternatively, several results showed that with a well-designed Coded OFDM system, modest dispersion can improve, rather than deteriorate, the bit error rate. If the entire MCM signal is subject to flat fading, i.e., if all sub carriers experience the same fading, bit errors occur on sub carriers are highly correlated. Error correction with code words spread across sub carriers may not be able to correct erased or wrong bits. In a channel with a larger delay spread, the coherence bandwidth can be such that fading only affects a limited number of sub carriers at a time. Forward error correction coding can successfully repair poor reception at those subcarriers. Interleaving in frequency domain, i.e., across subcarriers can be used to further improve the performance. Signals from different applications or programs are interleaved to achieve greater independence of fading of sub carriers for individual user data streams.

Additionally, frequency dispersion also called Doppler spreading can be caused by delay spreads in the multipath channel. If the symbol duration is relatively large, it is unlikely that the symbol energy completely vanishes during signal fade. However, OFDM sub carriers lose their mutual orthogonality if rapid time variations of the channel occur, which typically leads to increased bit error rates. Similarly, phase jitter or receiver frequency offsets also leads to interchannel interference. This sensitivity to frequency offsets, as well as to nonlinear amplification is often attributed to be one of major MCM disadvantages. A time-varying frequency error not only erodes the sub carrier orthogonality, but also makes sub carrier synchronization much more difficult to achieve and maintain.

The use of Fourier transforms in both the transmitter and receiver, allows MCM communication systems to reduce the effects of time dispersion and the effects of frequency dispersion. A maximum-length linear feedback shift register sequence can be used to find the delay profile of a time dispersive, i.e., frequency selective channel. If such a sequence is transmitted in multi-carrier format, i.e., after Fourier Transformation, it can be used to find the Doppler components of the frequency dispersive channel. In a mobile multipath channel, signal waves coming from different paths often exhibit different Doppler shifts. A MCM receiver can detect the individual components by searching shifted versions of the sequence at the output pins of the FFT. The resulting correlation pattern can be used to steer the local oscillator to better track the signal.

OFDM generally uses fixed sub-bands and pilot/tracking/traffic channel formats with no spectrum spreading for either CDMA frequency re-use benefits or for low probability of intercept/antijam (LPI/AJ) processing gain needed for military applications. It is therefore desirable to provide an improved modulation technique to reduce the effects of heavy absorption of direct signal path propagation and the effects of multipath.

### SUMMARY

In accordance with the present invention, a method of providing a spread spectrum radio frequency communication signal includes the steps of forming a stream of data into a plurality of data packets and embedding each data packet into a physical layer packet including the steps of adding a packet header, performing a cyclic redundancy check and encoding the data. The encoding the data step includes the steps of encoding digital data with a Reed Solomon forward error correction algorithm to provide RS symbols and interleaving the RS symbols across a plurality of coherent sub-bands. The method further includes the step of encoding each interleaved RS symbol with a low rate Walsh code. With such a technique, spread spectrum bandwidth is divided into coherent sub-bands and forward error correction (FEC) is used to erase symbols transmitted on faded or jammed sub-bands and to correct symbols transmitted on faded sub-bands with high sub-band error rates.

In accordance with a further aspect of the present invention, a spread spectrum radio frequency communication system includes a Forward Error Correction (FEC) algorithm to encode digital data to provide a plurality of symbol groups, the FEC algorithm using a Reed Solomon or a Turbo Code FEC code and an interleaving algorithm to map each one of the plurality of symbol groups into a corresponding one of a plurality of coherent sub-bands, and a Walsh encoder to encode each one of the plurality of symbol groups. With such an arrangement, multiple sub-bands contain partially redundant information such that many sub-bands can be lost and the information can still be regenerated.

The system further includes a transmission security device to encrypt each one of the Walsh encoded symbol groups and an Inverse Fast Fourier Transform (IFFT) coupled to the transmission security device. With such an arrangement, additional security can be provided as required by military systems with the advantages of the present invention.

### BRIEF DESCRIPTION OF THE DRAWINGS

The foregoing features of this invention, as well as the invention itself, may be more fully understood from the following description of the drawings in which:

FIG. 1 is a flow diagram for creating a transmit signal.

FIG. 2 is a block diagram of a spread spectrum radio frequency communication system according to the invention.

FIG. 3 is a plot showing the frequency spectra of the various sub-bands implementing the technique according to the invention.

FIG. 4A is a block diagram of a modulator and a corresponding demodulator accordingly to the invention.

FIG. 4B is a block diagram of an alternative modulator and corresponding demodulator accordingly to the invention.

FIG. 5 is a plot of Eb/NO required to achieve a given bit error rate for spread modulation.

FIG. 6 is a more detailed block diagram of a modulator accordingly to the invention.

### DETAILED DESCRIPTION

The following disclosure relates generally to systems, methods, and devices for transmitting wireless signals using spread spectrum radio signals.

Reference will now be made in detail to several embodiments, examples of which are illustrated in the accompanying figures. The figures depict embodiments of the present invention for purposes of illustration only, and are not intended to limit the scope of this disclosure in any manner. One skilled in the art will readily recognize that alternative embodiments of the structures and methods described may be employed without departing from the scope and principles of this disclosure.

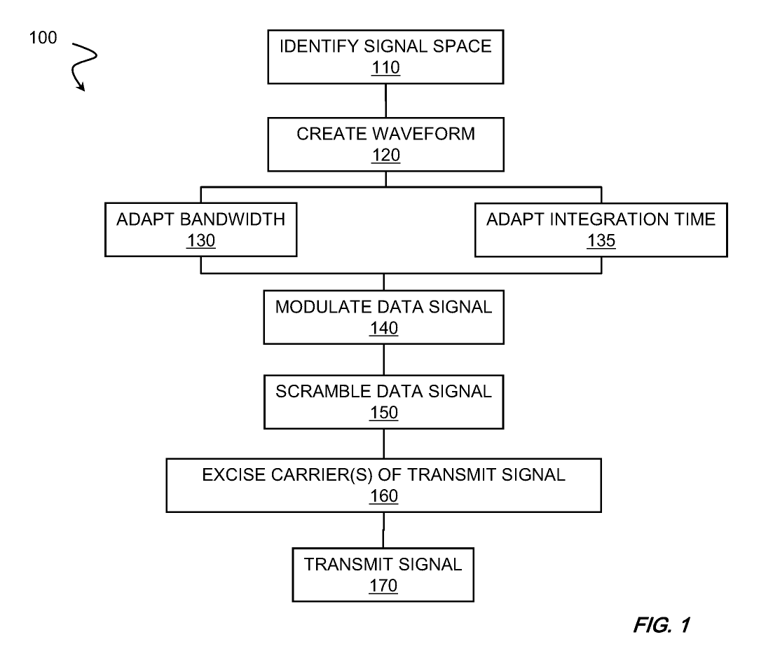

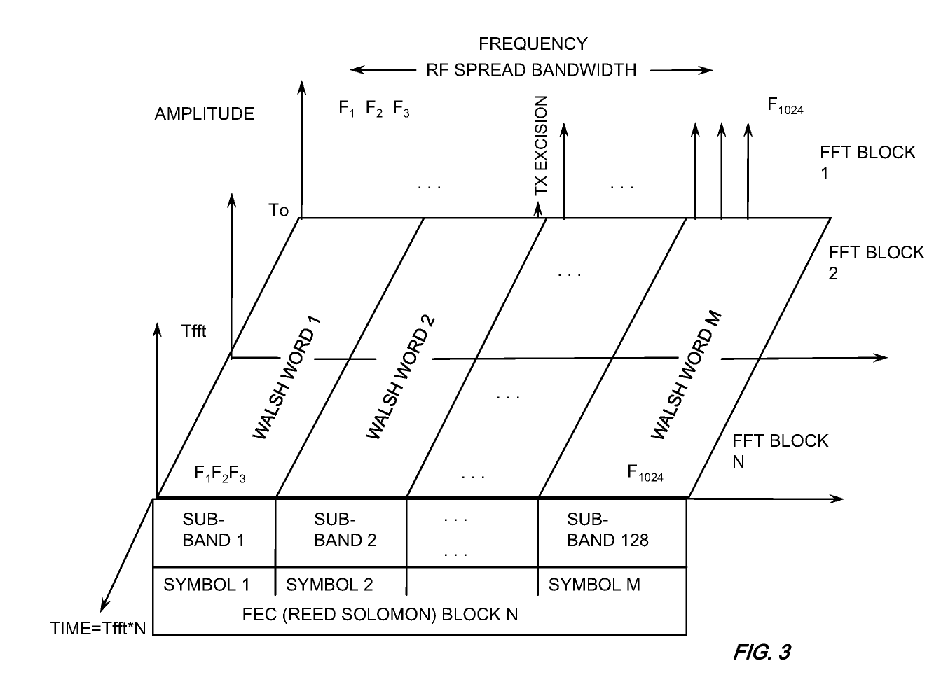

FIG. 1 is a flow diagram of a process 100 for preparing a signal to be transmitted. It will be understood that the process 100 is an exemplary embodiment only. Steps may be modified, rearranged, omitted or added all without deviating from the scope of this disclosure. A signal space may be identified as shown in step 110 including a range of frequencies over which a transmission may occur. One suitable signal space is illustrated, for example, in FIG. 3 which shows a range of frequencies that may be further channelized or divided using the techniques described herein into tiles or rectangles parameterized by, e.g., integration time and bandwidth (see FIG. 3) where each time-bandwidth product occupies a portion of the signal space. In this manner, the signal space may be allocated using a flexible time-frequency grid.

A waveform for the identified signal space may be created as shown in step 120. The waveform may be organized into a plurality of sub-bands for communication of data. Each sub-band may be defined, for example, by a time-frequency tile using the bandwidth and integration time as described above.

As shown in step 130, the waveform may be adapted to the available bandwidth based on the identified signal space. The bandwidth may be widened or narrowed for each sub-band. Also or instead, the integration time may be adapted (e.g., increased or decreased) as shown in step 135 so that the time over which an integration occurs for a signal within a sub-band may be lengthened or shortened. In various embodiments the integration time may be lengthened but the sub-bands may be shortened. More generally, integration time and bandwidth may be independently controlled to flexibly allocate time-frequency tiles within the signal space. Based on the signal space conditions (multipath, interference, jamming, etc.) the integration time and bandwidth may be adaptively matched or selected for the most efficient signal. In some embodiments both the bandwidth may be adapted and the integration time may be adapted. Further, the M-ary alphabet sizes, data rates, and processing gains used to encode/transmit data may also be adapted.

As shown in step 140, an input data signal may be modulated using direct sequence spreading for each of the sub-bands. Through this modulation the input data signal may be impressed onto the sub-band(s) to provide a transmit signal. The signal may for example be modulated into M time-frequency sub-bands or channels and may provide M-ary modulation. A preamble may be provided identifying the M-ary alphabet size and the M-ary alphabet being used. The preamble may also indicate the data rate being used. The preamble may also indicate the bandwidth and integration time of one or more of the time-frequency tiles. More generally, the preamble may encode any data useful for recognizing and extracting data signals from the time-frequency tiles of the signal space described above. The preamble approach may not require any lengthy signal training interval, convergence time, or pilot signal overhead. It may be particularly well suited to burst mode packet data communications.

As shown in step 150, the data signal may optionally be scrambled. This scrambling may be accomplished for example with a non-linear Transmission Security (TRANSEC) pseudo-noise overlay. TRANSEC is generally recognized as a component of communications security describing measures to protect transmissions from interception and exploitation, with more specific standards and protocols employed, for example, in military radios and the like.

As shown in step 160, the transmit signal may optionally have one or more specific carriers excised. Certain sub-bands may be faded due to jamming, interference, or other problems and therefore these carriers or sub-bands may be avoided. By removing these carriers, transmission energy may be substantially confined to sub-bands that can efficiently communicate the desired signal. Faded sub-bands may be deemphasized or erased.

As shown in step 170, the signal may be transmitted to communicate the underlying data signal. By using this method direct sequence spectrum spreading with large order M-ary coding using flexible time-frequency tiles across both dimensions simultaneously.

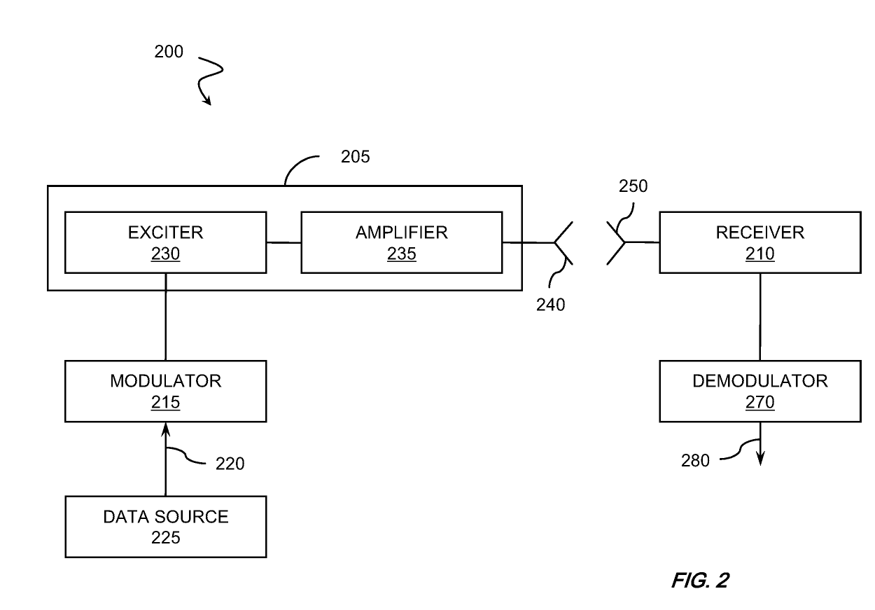

Referring now to FIG. 2, a spread spectrum radio frequency communication system 200 is shown to include a transmitter 205 and a receiver 210. The transmitter 205 is connected to a modulator 215 wherein an input data signal 220 from a data source 225 is encoded and modulated using a novel spread spectrum waveform as described hereinafter and a resulting modulated signal is fed to an exciter 230. The exciter 230 up converts the modulated signal to a transmit frequency signal and feeds the transmit frequency signal to an amplifier 235 to increase the power of the signal. The output signal from the amplifier is then fed to an antenna 240 for propagating a transmit RF signal. The transmit RF signal is captured by a receive antenna 250 which feeds a received signal to a receiver 210. The receiver 210 down converts the received signal to a baseband signal wherein the baseband signal is fed to the demodulator 270. The demodulator 270 then demodulates and decodes the baseband signal to an output data or receive data signal 280 as described hereinafter.

The novel spread spectrum waveform is a type of Orthogonal Frequency Modulation (OFDM) waveform wherein an OFDM waveform is combined with a unique coherent sub-band coding including Walsh Orthogonal Codes and Reed Solomon forward error correction (FEC) to provide reliable communications. The technique incorporates both transmit and receive frequency excision and Reed Solomon symbol erasures (erasure decisions use side information provided by the Walsh decoder) to provide performance gains in narrow band interference.

Frequency division—sequence spectrum spreading (FD-DSS) resembles OFDM, except that the sub-bands are not narrowband fixed channels, but rather, flexible time-frequency channels that allow direct sequence spectrum spreading with large order M-ary coding across both dimensions simultaneously. Variable coherent integration times, bandwidths, M-ary alphabet sizes, data rates, and processing gains allow adaptive matching or selection of the most efficient signal format for the channel conditions (i.e. multipath, interference, jamming, etc.) encountered on each link in a decentralized changing network. Redundancy across sub-bands is provided by forward error correction (FEC) coding across sub-bands and a sub-band quality measure step detects and erases corrupted frequency sub-bands before FEC decoding. Faded sub-bands are deemphasized (i.e. erased) in the decoding process, while the full information set is recovered from the surviving strong sub-bands, which may even be SNR enhanced by multipath. Rapid fast convolution acquisition and self discovery affords immediate reception without equalizer/RAKE training for efficient burst-mode channel sharing operations in multi-terminal ad hoc networks.

Direct sequence spread spectrum applied across both time and frequency provides a Gaussian amplitude distribution and suppressed cyclostationary feature waveform that is virtually indistinguishable from Gaussian noise, yielding excellent clandestine (LPI/LPD) communications. Spread spectrum processing gain spreads the information across a large transmission bandwidth reducing the power spectral density, and providing both LPI/AJ performance and the ability to perform CDMA channel sharing. Interference/jam resistance is further enhanced via narrowband excision of individual frequencies/sub-bands that are jammed by large intefererers.

FD-DSS modulation allows modifying the transmitted spectrum by inserting zero amplitude weights in any narrow-band frequency subset. This allows spectrum tailoring to fit any available frequency allocations, and improves co-site performance by virtue of both the transmit and receive excision of undesirable interference.

As described above, an OFDM waveform is essentially a multicarrier modulation technique where a large number of modulated carriers are transmitted simultaneously. The modulated carriers are separated in frequency so that they are orthogonal to one another. Examples of modulation used on the individual carriers in OFDM systems are BPSK, QPSK, and QAM. The total bandwidth taken up by all the carriers is the bandwidth of the OFDM waveform. The novel waveform is a spread spectrum waveform that is based on Orthogonal Frequency Division Modulation (OFDM). It utilizes 1024 carriers, with each carrier modulated with QPSK modulation. More generally, any number of carriers can be used, and each carrier may be modulated with M-PSK or M-QAM modulation.

In general, OFDM waveforms are modulated and demodulated using FFT algorithms. Since OFDM waveforms are a multicarrier modulation one might consider generating the modulation by independently generating the modulation on each carrier and then adding the waveforms together. For a large number of carriers this is not an efficient technique and a more efficient technique for generating the waveform uses FFTs. An array of complex number is used where each element in the array corresponds to one of the OFDM carrier frequencies. Each array element is filled with the complex value corresponding to the data imposed on the OFDM carrier represented by the array element. For example, if QPSK modulation is used on each carrier, then each element is filled with one of four complex values corresponding to the four QPSK phases. After the array is filled, an inverse FFT is performed. The resulting array is then the time domain representation of the data and is used as the waveform for transmission by the exciter 20. This process is then repeated again for each array element until the entire data packet is transmitted.

With a large enough number of carriers, mathematically the Central Limit Theorem implies the transmitted waveform takes on a Gaussian noise-like amplitude and phase distribution. The amplitude distribution is Rayleigh distributed and the phase distribution is uniformly distributed which is the same amplitude and phase distribution as additive white Gaussian noise. In addition to the Gaussian noiselike time domain signal, the power density across all the OFDM bandwidth is uniformly distributed so there is no distinguishing shape to the power spectral density of the waveform. Both these very desirable “featureless” properties distinguish the novel waveform. Traditional direct sequence waveforms do not possess these noise-like statistical properties, as well as dithered and filtered direct sequence waveforms fail to provide the uniform PSD and the noise-like amplitude distribution.

As an OFDM waveform, the novel waveform includes 1024 independent carriers across the signal bandwidth with each carrier transmitting QPSK modulation. All 1024 QPSK symbols on all 1024 carriers have the same symbol timing. All QPSK symbols on all the carriers are unshaped and therefore each symbol on a carrier includes a pure carrier in one of four phases for the entire symbol period. The frequency spacings of the carriers are the bandwidth divided by 1024. In a similar manner, the QPSK symbol rate for each carrier is the bandwidth divided by 1024. Thus for a 25.6 MHz bandwidth, the carrier spacing is 25 KHz and the QPSK symbol rate is 25 Ksps; for a 12.8 MHz bandwidth, the carrier spacing is 12.8 KHz and the QPSK symbol rate is 12.8 Ksps, and so on.

The novel OFDM waveform utilizes a unique approach to multipath mitigation that is optimized for a mobile packet network and does not have the training and convergence problems of other OFDM equalization techniques. The novel technique is based on sub-band coding where the spread bandwidth is divided into sub-bands and forward error correction (FEC) is used to erase symbols transmitted on faded or jammed sub-bands and to correct symbols transmitted on faded sub-bands with high sub-band error rates.

The 1024 carriers are grouped into coherent sub-bands of contiguous frequencies. The number of sub-bands is configurable and vary from a minimum of 32 sub-bands to a maximum of 256 sub-bands. The more sub-bands, the fewer frequencies within each sub-band such that with 32 sub-bands, the number of frequencies within the sub-band would equal 32, with 64 sub-bands, the number of frequencies within the sub-band would equal 16, with 128 sub-bands, the number of frequencies within the sub-band would equal 8 and with 256 sub-bands, the number of frequencies within the sub-band would equal four. In a highly urban environment, typically 32 sub-bands would be used. In a rural or airborne environment, typically 128 sub-bands would be used.

With a network that provides for various communication modes with different throughput rates, processing gains and link robustness, the basic waveform is parameterized so that it can be configured to match the requirements of a particular network link and the waveform can support bandwidths of 25.6 MHz, 12.8 MHz, 6.4 MHz, 3.2 MHz and 1 MHz.

The data to be transmitted is fed to a modem (not shown) which packetizes the data stream. Each data packet is then embedded into a physical layer packet which adds a packet header, performs a cyclic redundancy check (CRC) and encodes the data. The physical layer packet encoding utilizes two coding processes that are concatenated together. The first process encodes baseband data with a Reed Solomon (RS) FEC to provide RS symbols. The RS symbols are then interleaved across the sub-bands. The interleaving assures that only one RS symbol from any RS block is transmitted within any sub-band. The second coding process is a sub-band coding process that encodes the symbols transmitted within each sub-band. Sub-band coding is performed with low rate Walsh codes. Thus the RS symbols that have been interleaved within a sub-band are further encoded with a low rate Walsh orthogonal code.

The fundamental FD-DSS novel waveform utilizes a two dimensional time/frequency plane for data and spread spectrum chip modulation. FIG. 3 illustrates its signal space. Each data symbol occupies a time-bandwidth product that typically spans less than the entire allocated bandwidth (BW). The channel is partitioned into sub-bands, each with limited coherent integration bandwidth. Fitting the coherent BW bandwidth of the signal to no more than the channel supports is a key to achieving high multipath resistance. For HF that bandwidth may be only one KHz, at VHF maybe 100 KHz. In general, the emphasis is to integrate longer in time, but over shorter sub-bands. Thus, each sub-band becomes a single frequency bin, integrated over a full data bit time, but there is no spread spectrum processing gain across frequency.

Spread spectrum is the foundation of any LPI/AJ signal design and LPI specifically requires some DSS (not pure frequency hop) to decrease the power spectral density. But a wide bandwidth DSS signal (i.e. greater than one MHz) typically spans more than the coherent bandwidth supported by an HF/VHF channel, resulting in frequency selective in-chip fades and distortion. Sub-bands serve to isolate frequency selective fades to small enough entities such that sub-bands may be erased. FEC coding redundancy using a Reed-Solomon algorithm then recovers the data that was lost in any discarded sub-bands. Further this OFDM-like channel compensation is immediate, and does not require any learned knowledge of the channel. There is no training interval delay or overhead, as with adaptive channel equalization techniques. A receiver instantly compensates for any type of channel degradation.

FFT's enable frequency domain processing of parallel independent sub-bands. Equal resolution against fading and jamming interference of all cells is critical. The signal can be no more vulnerable to the loss of one given sub-band than to any other. Further, FFT's offer other significant benefits, such as a featureless Gaussian noise-like waveform (truly high LPI), narrowband excision (vs. jamming and transmitter EMI), spectral shaping/masking, and rapid parallel-search acquisition (fast convolution) to enable non-blocking TDMA MACs

Large-order M-ary orthogonal modulation, realized using Walsh functions (much like CDMA/PCS cellular), provides extremely efficient Eb/No performance against additive white Gaussian noise (AWGN), typically about 3.5 dB for M=1024 and BER=10⁵. Walsh functions are also particularly well suited for spread spectrum signals, since they already spread K bits into M=2K chips in each M-ary symbol. A TRANSEC PN (pseudonoise sequence) overlay scrambles the Walsh words by modulo-2 addition to the M Walsh chips, protecting against enemy exploitation of the known Walsh code sets.

The combined Walsh/TRANSEC chip stream multiplies the phase coefficient of each FFT bin, impressing independent phase modulation upon each sub-carrier. The random phase difference across the channel creates a Gaussian noise-like signal characteristic and it is virtually featureless against cyclostationary detectors. The time domain pattern is truly noise, and a constellation scatter diagram is a uniform cloud. There are no discernible high points in any distribution.

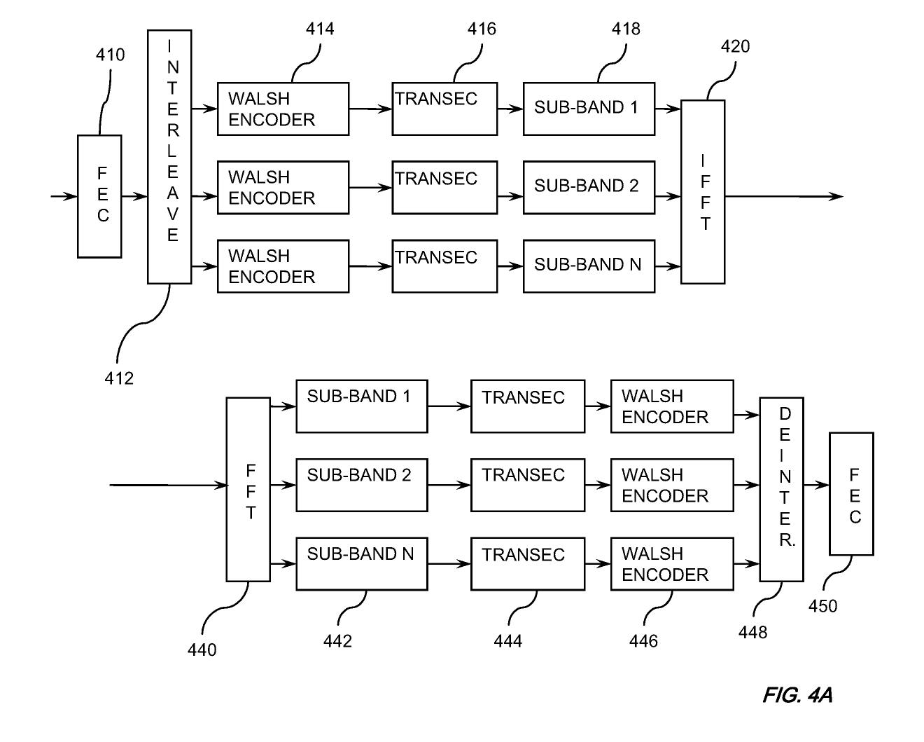

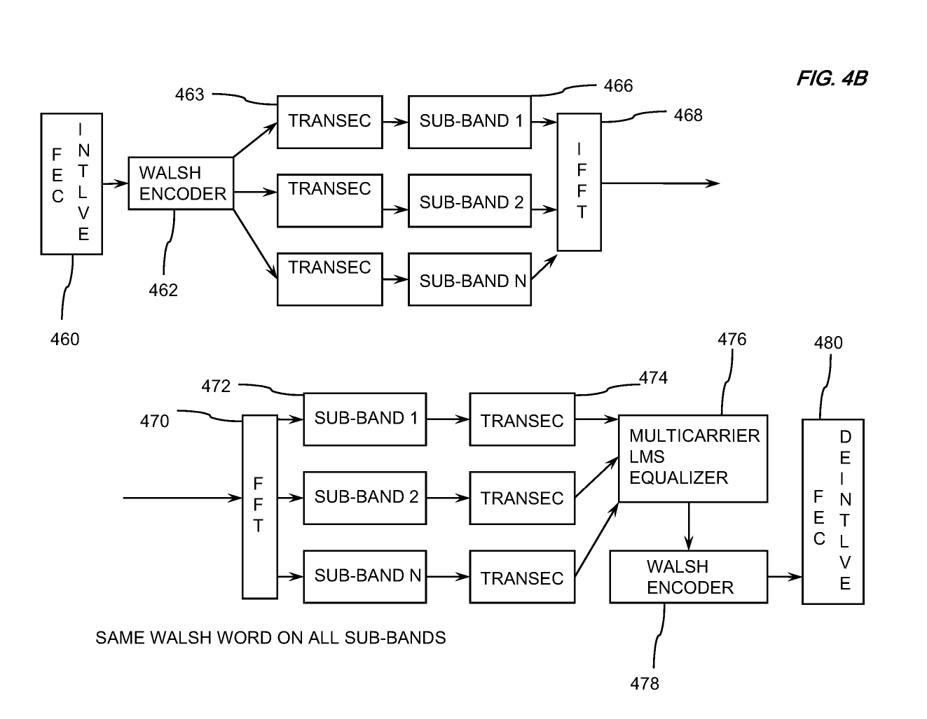

As with any modulation technique, transmission of information requires data to be impressed onto the FD-DSS modulation. Two techniques for impressing baseband data onto the sub-band modulation are illustrated in FIGS. 4A and 4B, respectively. The first technique requires no equalization and therefore requires neither equalizer convergence nor tracking. The second technique makes use of an adaptive equalizer and requires both equalizer convergence and tracking. In the first technique as shown in FIG. 4A, the digital data is encoded with a Forward Error Correction (FEC) code as shown by FEC block 410 prior to modulation, for example a Reed Solomon FEC code can be used. Alternatively, a Turbo Code, convolutional code, or other block FEC code could be used. The encoded data is optimally interleaved as shown by interleave block 412 across the sub-bands so that the FEC symbol N of any single code block are distributed uniformly across the sub-bands. After each block symbol is segmented into RS symbols, each segmented symbol is grouped into sets of N (N=8, 12, 16 or 24 depending on the mode) symbols and then each N symbol group is FEC encoded. A 32 symbol block, with 32 RS symbols, is then mapped into the sub-bands. With 32 sub-bands, we map the 32 symbols into the 32 sub-bands one to one. With 64 sub-bands, we map RS block 1 symbols into sub-bands 1, 3, 5, 7, etc. and map RS block 2 symbols into sub-bands 2, 4, 6, 8, etc. With 128 sub-bands, we map RS Block 1 symbols into sub-bands 1, 5, 9, etc., map RS block 2 symbols into sub-bands 2, 6, 10, etc., map RS block 3 symbols into sub-bands 3, 7, 11, etc. and map RS block 4 symbols into sub-bands 4, 8, 12, etc. and so forth for 256 sub-bands, etc. Optimally, no sub-band includes more than one FEC symbol from a code block. The loss of sub-bands to multipath fading, jamming, etc. is then recovered through the FEC decoding process. Any sub-band lost to fading or jamming eliminates at most one FEC symbol from any FEC code block so that as long as the number of lost sub-bands is less than the correction capability of the code, the transmitted data is recovered. Each sub-band has a corresponding Walsh encoder 414 wherein the interleaved RS signal is Walsh encoded in a known manner. The Walsh encoded RS signal is then encrypted by a transmission security device 416 and fed to sub-band filter 418. The output of the respective sub-band filters 418 are fed to an Inverse Fast Fourier Transform (IFFT) 420 wherein the signal is fed to the exciter 230.

In the receiver 210, a received signal is fed to a Fast Fourier Transfer (FFT) 440 wherein the signal is divided into a plurality of sub-band signals which are fed to corresponding sub-band filters 442. Each one of the sub-band signals are decrypted by a transec device 444 and fed to a Walsh decoder 446. The signals are then de-interleaved as shown by block 448 and fed to forward error correction device 450. FEC decoding can be performed using soft output from the sub-band Walsh decoder allowing either full maximum likelihood soft inputs to the decoder or alternatively sub-band and symbol erasures. In embodiments FEC symbols may be interleaved into different sub-bands.

As shown in FIG. 4B, the second technique transmits the same data on all or a portion of the sub-bands. With this technique data redundancy is obtained through the repeated data on all the sub-bands. In this embodiment, the digital data is encoded with a Forward Error Correction (FEC) code as shown by FEC block 460 using a Reed Solomon FEC code. The output is fed to a Walsh encoder 462 wherein the RS signal is Walsh encoded in a known manner. The Walsh encoded RS signal is then fed to each of the respective sub-band channels to be encrypted by a transmission security device 464 and then fed to sub-band filter 466. The output of the respective sub-band filters 466 are fed to an Inverse Fast Fourier Transform (IFFT) 468 wherein the signal is fed to the exciter 230.

In this embodiment of the receiver 210, a received signal is fed to a Fast Fourier Transfer (FFT) 470 wherein the signal is divided into a plurality of sub-band signals which are fed to corresponding sub-band filters 472. Each one of the sub-band signals are decrypted by a transec device 474 and fed, via a multicarrier LMS equalizer 476, to a Walsh decoder 478. The signals are then fed to forward error correction device 480. FEC decoding can be performed using soft output from the sub-band Walsh decoder allowing either full maximum likelihood soft inputs to the decoder or alternatively sub-band and symbol erasures.

The received signal contains replicates of the data on each sub-band with more or less fidelity depending on the degree of fading or jamming on each individual sub-band. To recover the data, the data replicated on all the sub-bands are optimally combined weighting the data in each sub-band in proportion to the fidelity of the sub-band. This optimal combining of sub-bands is performed with an adaptive equalizer at the receiver such as a Least Mean Square equalizer, Viterbi equalizer or other linear or nonlinear equalizer.

It should be appreciated that sub-band mapping assures that only a single RS symbol from any RS block is mapped into a sub-band thus a faded or jammed sub-band destroys only a single RS symbol from anyone RS block. As described, the first encoding process, RS encoding and interleaving across sub-bands is as follows. Each block symbol is segmented into, here 5, bit RS symbols. Next, each segmented symbol is grouped into sets of N (N=8, 12, 16 or 24 depending on the mode) symbols and then each N symbol group is FEC encoded. The 32 symbol block, with 32 RS symbols, is then mapped into the sub-bands. With 32 sub-bands, we map the 32 symbols into the 32 sub-bands one to one. With 64 sub-bands, we map RS block 1 symbols into sub-bands 1, 3, 5, 7, etc. and map RS block 2 symbols into sub-bands 2, 4, 6, 8, etc. With 128 sub-bands, we map RS Block 1 symbols into sub-bands 1, 5, 9, etc., map RS block 2 symbols into sub-bands 2,6, 10, etc., map RS block 3 symbols into sub-bands 3, 7, 11, etc. and map RS block 4 symbols into sub-bands 4, 8, 12, etc. and so forth for 256 sub-bands, etc. This mapping of each RS block symbol into a different sub-band instead of the same sub-band provides the advantage of the present invention.

Each symbol from a RS block is transmitted on a unique sub-band, so that a faded or jammed sub-band interferes with at most one symbol from an FEC block. The process of interleaving RS symbols across sub-bands is a key factor to improving multipath fading capabilities of the waveform, because it assures that any faded or jammed sub-band will corrupt only a single RS symbol from an y RS Block. Of course, there are many RS symbols transmitted in each sub-band, but each RS block has at most one symbol residing in a sub-band. For example, in the 25.6 MHz, the bandwidth may be divided into 128 sub-bands. If a RS(32, 16) rate ½ FEC is used, then the symbols from a RS block are all placed in different sub-bands and are separated by 4 sub-bands from one another. For example, the 32 symbols from a RS block may be in the 32 sub-bands 1, 5, 9, 13 etc.

During demodulation, first the Walsh encoded data in each sub-band is decoded and then second, the decoded symbols from all the sub-bands are deinterleaved and RS decoded. The sub-band Walsh decoding process provides a quality measure of the decoded symbols in the sub-band Walsh word. The Walsh decoder can detect whether the sub-band cannot be reliably decoded such as when the sub-band is faded or jammed. This quality information is passed onto the RS decoder to aid in the second decoding step. If the quality measure is below a threshold, the RS decoder is told to “erase” the symbol residing in the Walsh word. This erasure process prevents errors from reaching the Reed Solomon decoder and significantly improves the performance of the RS decoder because the RS decoding algorithm performs better if it knows a symbol is unreliable. For example, an RS(32,16) FEC can correct up to 8 errors, but can fill in up to 16 erasures. The decoder's performance against a combination of errors and erasures improves as more errors are detected and converted to erasures. This means that with an RS(32,16) FEC, up to half the sub-bands across the spread bandwidth can be faded or jammed and the waveform can still recover the transmitted data. Using a more powerful FEC such as an RS(32,8), up to ¾ of the sub-bands can be jammed or faded.

We will now describe how the novel waveform utilizes Walsh Coding to expand waveform bandwidth and to provide spread spectrum processing gain. Processing gain can be defined as the ratio of the waveform bandwidth to the information bit rate. Traditionally, direct sequence processing gain is achieved by mapping each data bit into a digital waveform made up of many pseudorandom channel bits. One common way of accomplishing this is as follows. For each data bit, a large number of pseudorandom channel bits are generated. If the data bit is “1” the pseudorandom sequence is left unchanged. If the data bit is a “0”, the pseudorandom sequence is inverted, that is “1”s are changed to “0” and “0”s are changed to “1”. F or example, for each data bit, 100 pseudorandom channel bits may be generated and then transmitted. In this case, the bandwidth is increased by 100 yielding a 20 dB processing gain. On the channel, each chip might be used to modulate a BPSK modulation, or pairs of chips might be used to modulate a QPSK modulation. The bit error rate performance of such a system is that of QPSK. Of course forward error correction is almost always used to improve the performance beyond that of uncorrected QPSK.

It should be appreciated that a technique of achieving direct sequence processing gain, which is used in the novel waveform, is to spread using orthogonal sequences such as Walsh codes. Walsh codes are orthogonal codes that map “w” bits into 2^{w} chips, where w is an integer selected for the waveform operating mode. For example a 1024 chip Walsh encoder takes 10 bits and maps them into 1024 chips. Similarly a 32 chip Walsh encoder takes 5 bits and maps them into 32 chips. Different operating modes use different size Walsh codes. Typically 32, 1024, 2048 and 4096 chip Walsh codes are used in operating modes. Walsh coding provides processing gain because it expands the signal bandwidth. For example, if 1024 Walsh sequences are used then for each 10 bits of data, 1024 Walsh chips are transmitted, expanding the bandwidth 102.4 times. This provides a processing gain of 20. To achieve higher processing gains, longer Walsh Sequences can be used. Alternatively, processing gain can be increased by repeating each Walsh word many times.

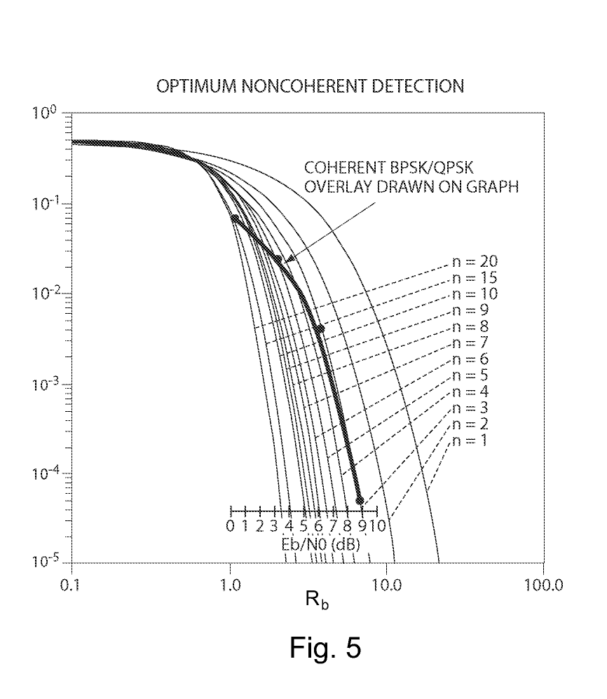

The advantage of spreading through orthogonal sequences (such as Walsh codes) is illustrated in FIG. 5. The figure gives curves for the Eb/NO required to achieve a given bit error rate for non-orthogonal modulation for Walsh Sequence lengths up to 1,000,000 chips. A second curve overlaid onto the figure gives the Eb/NO required for BPSK/QPSK (spread) modulation. It's clear from the figure that utilizing large m Walsh sequences significantly reduce the Eb/NO required for communications. The curve also illustrates the diminishing returns obtained as the Walsh sequences get longer and longer. 1024 chip Walsh sequences achieve a gain of more than 4 dB over conventional QPSK spreading modulation. In addition by increasing the sequences 100 fold to 100000 chips long, only about another 1 dB is achieved. Based on this analysis, the preferred modulation uses Walsh sequences of length no longer than 4096 chips. As described above, arbitrarily large processing gains can be achieved by simply repeating Walsh sequences over and over.

For each sub-band, the bitstream assigned to the sub-band are Walsh encoded. Walsh codewords of size 32, 1024, 2048 and 4096 chips are used depending on the communication mode. Depending on the mode of operation, the Walsh encoder either maps 5 bits to 32 Walsh chips, 10 bits to 1024 Walsh chips, 11 bits to 2048 Walsh chips, or 12 bits to 4096 Walsh chips. As shown in FIG. 5, sub-band bits are grouped into groups of m=(5, 10, 11, or 12) bits. Each group is then mapped into a Walsh codeword of size 2 μm chips (32, 1024, 2048 or 4096). Depending on the data rate and other requirements for the network mode of operation, Walsh words are repeated many times to increase the processing gain (and effectively lower the data throughput by increasing the energy transmitted per bit). All sub-bands are processed in exactly the same manner, so that the size of Walsh words and the number of repeats are the same for each sub-band. If R is defined to be the number of repeats of each Walsh word, then for every m bits assigned to a sub-band, there are R*2^{m} Walsh chips generated to be transmitted within the sub-band. As described above, each of these R*2^{m} Walsh chips is TRANSEC covered by mapping the chip into a pseudorandomly selected QPSK symbol using TRANSEC supplied pseudorandom bits. For each Walsh data chip, two TRANSEC bits are used to select a QPSK symbol (one of four phases). The Walsh data chip is then used to either keep the QPSK symbol unchanged or to rotate the symbol by 180 degrees.

All the chips within a Walsh codeword are transmitted in the same sub-band. In general, however, each Walsh word contains more chips than frequencies within a sub-band. For example, if the band is divided into 64 sub-bands and modulation uses 2048 chip Walsh words in each sub-band, then only 16 chips from each of 64 different Walsh Words can be transmitted each chip time. That is, each chip time a QPSK symbol is transmitted on each frequency. With 64 sub-bands, each sub-band contains only 16 frequencies, so only 16 Walsh chips from each Walsh word are transmitted. To transmit the entire set of 64 Walsh words (one in each sub-band), 128 symbol periods are required. If the waveform is generated with FFTs, then 128 FFTs are required to send the 64 Walsh words.

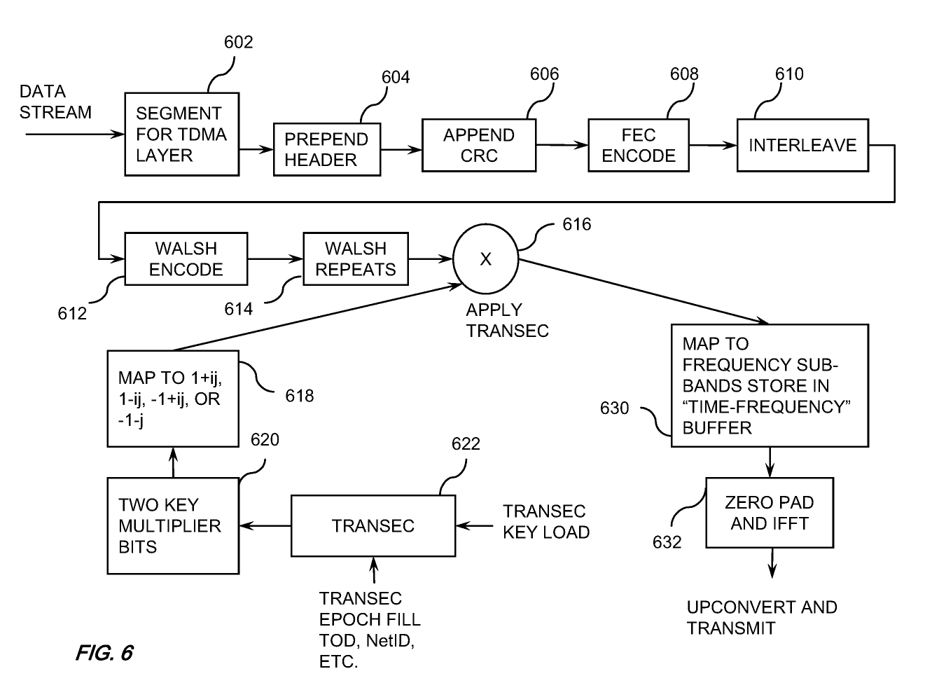

FIG. 6 summarizes the flow of the transmit processes and waveform processing as described above. The receive processes are just the inverse of the processes shown in FIG. 6. The data stream to be transmitted is first packetized into physical layer packets as shown in block 602. A packet header as shown in block 604 and CRC as shown in block 606 are then added to each packet, and the resulting packet is FEC encoded as shown in block 608 and interleaved as shown in block 610. Next, spread spectrum bandwidth expansion is implemented using very low rate Walsh orthogonal sequences to both encode the symbols and expand the bandwidth as shown in blocks 612 and 614. Frequency domain spread spectrum chipping may be accomplished. Waveform spread bandwidth may be expanded using very low rate wash codes. The Walsh encoding creates a sequence of BPSK chips (1 or −1). TRANSEC is then applied to the chip sequence as shown by multiplier 616. Each chip is multiplied by a unique QPSK TRANSEC symbol. For each Walsh chip, two TRANSEC bits are generated as shown in blocks 620 and 622. The two bits are used to select the pseudorandom the QPSK symbol to be multiplied by the Walsh chip as shown in block 618. Following TRANSEC, the QPSK symbols are mapped into frequency sub-bands as shown in block 630 as previously explained. A memory buffer is used to store the QPSK symbols as they are mapped into the sub-bands. At this point, the packet chip sequence is ready to be converted from the frequency domain to the time domain. This operation is performed with an inverse FFT as shown in block 632. The time domain sequence out of the FFT is up converted and transmitted.

The novel waveform easily supports both transmit and receive frequency excision. Whole sub-bands as well as individual frequencies can be excised. Transmit excision is important to prevent co site interference with collocated communications equipment. The concept behind transmit excision is very simple. Those sub-bands that contain frequencies used by collocated equipment will be zeroed out in the frequency domain prior to the transmit inverse FFT. Thus no signal is transmitted on those selected frequencies. Transmit frequency zeroization can be done either cooperatively or without the knowledge of the receiving terminal. If transmit excision is done without the receiver's knowledge, then the receiver's sub-band erasure rates will increase on those sub-bands with excised frequencies. This will reduce the sensitivity of the receiver. The sensitivity reduction depends on how many of the 1024 frequencies are excised. If transmit excision is done cooperatively with the receive terminal, then frequency excision will excise whole sub-bands at a time, and both the transmitter and receiver will perform a different sub-band mapping that avoids mapping symbols into excised sub-bands. In this case, data rate is reduced, but sensitivity is not.

All publications and references cited herein are expressly incorporated herein by reference in their entirety.

Having described the preferred embodiments of the invention, it will now become apparent to one of ordinary skill in the art that other embodiments incorporating their concepts may be used. It is felt therefore that these embodiments should not be limited to disclosed embodiments but rather should be limited only by the spirit and scope of the appended claims.

What is claimed is:

1. A method of operating a wireless transmitter comprising:
identifying a signal space for wireless communication, the signal space including a range of frequencies;
creating a waveform for the signal space, the waveform organized into a plurality of sub-bands, each one of the plurality of sub-bands defined by one of a plurality of time-frequency tiles characterized by a bandwidth and an integration time;
adapting at least one of the bandwidth and the integration time for the one of the plurality of the time-frequency tiles to provide a channel having a tile size selected to maintain a predetermined phase coherency across the one of the plurality of time-frequency tiles;
modulating a data signal onto the waveform using direct sequence spreading for each one of the plurality of sub-bands, thereby providing a transmit signal; and
transmitting the transmit signal into the signal space.

2. The method of claim 1 wherein the creating a waveform includes adding a preamble that includes an indication of the bandwidth and the integration time of at least one of the plurality of time-frequency tiles.

3. The method of claim 2 wherein the preamble includes an indication of one or more of an M-ary alphabet size and a data rate for the at least one of the plurality of time-frequency tiles.

4. The method of claim 3 wherein at least one of the M-ary alphabet size and the data rate vary over time.

5. The method of claim 4 wherein the M-ary alphabet size and the data rate vary from burst to burst in a packetized data system.

6. The method of claim 1 further comprising adapting the bandwidth and the integration time of all of the time-frequency tiles to provide a plurality of channels each having a coherent time-bandwidth product.

7. The method of claim 1 wherein all of the plurality of time-frequency tiles have a common bandwidth and a common integration time.

8. The method of claim 1 wherein the adapting at least one of the bandwidth and the integration time includes changing at least one of the bandwidth and the integration time between a plurality of bursts of data transmission.

9. The method of claim 1 wherein an actual phase coherency of a channel is determined according to one or more of experiment, radio frequency monitoring, and an estimate for an environment.

10. The method of claim 1 wherein the signal space is used for ad hoc mobile network communications.

11. The method of claim 1 wherein the data signal includes an ad hoc mobile network data.

12. The method of claim 1 wherein the modulating the data signal onto the waveform includes forward error correction encoding the data signal and interleaving of the data signal, thereby providing signal diversity across time and frequency.

13. The method of claim 1 further comprising excising one or more of a plurality of carriers of the transmit signal by using a zero amplitude signal.

14. The method of claim 1 further comprising scrambling the data signal with a non-linear Transmission Security (TRANSEC) pseudo-noise overlay.

15. The method of claim 1 wherein the transmit signal carries the data signal at a magnitude substantially within a noise floor for the signal space.

16. A device comprising:
a data source providing a data signal;
a transmitter adapted to create a waveform for a signal space including a range of frequencies, the waveform organized into a plurality of sub-bands, each one of the plurality of sub-bands defined by one of a plurality of time-frequency tiles characterized by a bandwidth and an integration time, the waveform including a preamble that includes the bandwidth and the integration time of the plurality of time-frequency tiles, the transmitter further adapted to adjust the bandwidth and the length of time of one of the time-frequency tiles to provide a channel having a tile size selected to maintain a predetermined phase coherency across the time-frequency tile; and
a modulator adapted to modulate the data signal onto the waveform using direct sequence spreading for each one of the plurality sub-bands, thereby providing a transmit signal;
wherein the transmitter is further adapted to transmit the transmit signal into the signal space.

17. The device of claim 16 wherein the waveform includes a preamble including an indication of the bandwidth and the integration time of at least one of the plurality of time-frequency tiles.

18. The device of claim 16 wherein the transmitter is further adapted to adjust the bandwidth and the integration time of all of the time-frequency tiles to provide a plurality of channels each having a coherent time-bandwidth product.

19. The device of claim 18 wherein all of the time-frequency tiles have a common bandwidth and a common integration time.

20. The device of claim 16 wherein at least one of the bandwidth and the integration time are adjusted by changing at least one of the bandwidth and the integration time between a plurality of bursts of data transmission.
